(19) United States
(12) Patent Application Publication
(10) Pub. No.: US 2004/0237999 A1
(43) Pub. Date: Dec. 2, 2004

(54) Electrically conductive material printing apparatus, printing mask cleaning method, and printing mask cleaning program

(76) Inventor: Masakuni Shiozawa, Sakata-shi (JP)

Correspondence Address: HARNESS, DICKEY & PIERCE, P.L.C., P.O. BOX 828, BLOOMFIELD HILLS, MI, 48303, US

(21) Appl. No.: 10/769,737

(22) Filed: Jan. 30, 2004

(30) Foreign Application Priority Data
Jan. 31, 2003 (JP) 2003-024648

(51) Int. Cl. B05C 1/00; B08B 6/00; C25F 5/00

(52) U.S. Cl. 134/1.3; 118/213; 118/203; 134/32; 134/61

(57) ABSTRACT

To shorten the time required to clean a printing mask used in printing solder paste pattern, an unused surface of a cotton cleaning sheet is brought into contact with a transfer surface of a printing mask while a feed roller, suction roller, take-up roller, solvent dispenser and air blower are moved horizontally in an integral fashion in a direction perpendicular to the direction in which a tape substrate is conveyed, thereby cleaning the printing mask along the shorter, widthwise direction of the tape substrate.

### RELATED APPLICATIONS

The present application claims priority to Japanese Patent Application No. 2003-024648 filed Jan. 31, 2003 which is hereby expressly incorporated by reference herein.

### BACKGROUND

1. Field of the Invention

The present invention relates to an apparatus for printing an electrically conductive material, a method for cleaning a printing mask, and a program for cleaning a printing mask, and more particularly is well suited for application to a method for cleaning a printing mask after the printing mask has been used to print solder on, for example, a tape substrate mounted with electronic components.

2. Description of the Related Art

Manufacturing semiconductor devices may include a step wherein a reflow method is used to attach a semiconductor chip, for example, to a circuit substrate on a COF (chip on film) module, TAB (tape-automated bonding) module, or the like. Here, if the tape substrate is to be reflow soldered, a method for batch-heating a plurality of circuit blocks, sites on the tape substrate where electronic components are mounted, may be used to improve production efficiency. For this reason, in a step prior to reflow processing, the solder paste pattern formed on a printing mask is transferred to the tape substrate so as to batch-print the solder paste pattern on a plurality of circuit blocks.

If the transfer surface of the printing mask is dirty, conveyance of the tape substrate is temporarily halted, and the transfer surface of the printing mask is wiped with a cotton cleaning cloth wetted with a solvent, thereby cleaning the printing mask.

However, a method for batch-printing a solder paste pattern on a plurality of circuit blocks needs an elongated printing mask, and cleaning the transfer surface of the printing mask with a cotton cleaning cloth requires a long stroke.

For this reason, the period of time required to clean the printing mask is longer, as is the period during which conveyance of the tape substrate is halted. Therefore, instead of increasing production efficiency, this method can, conversely, hinder production efficiency.

Therefore, the present invention is intended to provide an apparatus for printing an electrically conductive material, a method for cleaning a printing mask, and a program for cleaning a printing mask that can shorten the time required to clean a printing mask used in printing an electrically conductive material.

### SUMMARY

In order to solve the aforementioned problem, according to a first aspect of the present invention, the apparatus for printing an electrically conductive material comprises a printing mask that transfers an electrically conductive material onto a continuous body along which a row of circuit blocks is arrayed, and a cleaning means that cleans a transfer surface of the printing mask, by conveying a cleaning material in a direction crosswise to the direction in which the continuous body is conveyed.

The present invention thereby enables the printing mask to be cleaned along a direction other than the direction in which the continuous body is conveyed. Accordingly, even in cases where the printing mask is lengthened along the direction in which the continuous body is conveyed, increases in the travel distance of the cleaning material can be restrained, and the time required to clean the printing mask can be shortened, thereby making it possible to improve production efficiency.

In addition, according to a second aspect of the present invention relating to the apparatus for printing an electrically conductive material, the cleaning means horizontally moves the cleaning material in a direction perpendicular to the direction in which the continuous body is conveyed.

The present invention thereby allows the cleaning material to be moved along the direction perpendicular to the direction in which the continuous body is moved. Accordingly, even in cases where the printing mask is lengthened along the direction in which the continuous body is conveyed, increases in the travel distance of the cleaning material can be restrained, and the time required to clean the printing mask can be shortened.

In addition, according to a third aspect of the present invention relating to the apparatus for printing an electrically conductive material, the length of the printing mask corresponds to the length of a plurality of circuit blocks.

Hence, the present invention, by transferring the electrically conductive material formed on the printing mask to the continuous body, enables a solder paste pattern to be batch-printed on a plurality of circuit blocks, thus enabling production efficiency to be improved when mounting electronic components on the continuous body.

In addition, according to a fourth aspect of the present invention relating to the apparatus for printing an electrically conductive material, the width of the cleaning material is at least as long as the transfer surface of the printing mask.

The present invention thereby enables the cleaning material to be brought into contact with a plurality of circuit blocks, thus allowing the transfer surface of the printing mask to be batch-cleaned. Accordingly, even in cases where the length of the printing mask corresponds to the length of a plurality of circuit blocks, the time required to clean the printing mask can be shortened and, thus, the period during which conveyance of the continuous body is halted can be shortened, thereby enabling production efficiency to be improved.

In addition, according to a fifth aspect of the present invention relating to the apparatus for printing an electrically conductive material, the cleaning means includes a feed roller that feeds the cleaning material; a take-up roller that rolls up the cleaning material; a solvent dispenser that wets the cleaning material fed out from the feed roller with the solvent and presses the cleaning material against the transfer surface of the printing mask; a suction roller on which the cleaning material is caught and passed, for suctioning off contaminants adhering to the cleaning material; a horizontal transport means that horizontally transports the feed roller, the take-up roller, the suction roller, and the solvent dispenser in an integral fashion; a first vertical transport means that raises and lowers the solvent dispenser; and a second vertical transport means that raises and lowers the suction roller.

The present invention thereby enables the unused surface of the cleaning material to be brought into contact with the transfer surface of the printing mask and the printing mask to be cleaned along a direction other than the direction in which the continuous body is conveyed. In addition, the present invention makes it possible to prevent the re-adherence of contaminants removed from the transfer surface of the printing mask. Hence, the present invention makes it possible to efficiently clean the transfer surface of the printing mask.

In addition, according to a sixth aspect of the present invention, a method for cleaning a printing mask comprises a step for transferring an electrically conductive material formed on a printing mask to a continuous body along which a row of circuit blocks is arrayed; a step for bringing a cleaning material into contact with a transfer surface of the printing mask; and a step for conveying the cleaning material in a direction crosswise to the direction in which the continuous body is conveyed while rolling up the cleaning material that is brought into contact with the transfer surface.

The present invention thereby enables the unused surface of the cleaning material to be brought into contact with the transfer surface of the printing mask and the printing mask to be cleaned along a direction other than the direction in which the continuous body is conveyed. Accordingly, even in cases where the printing mask is lengthened along the direction in which the continuous body is conveyed, increases in the travel distance of the cleaning material can be restrained, and the time required to clean the printing mask can be shortened.

According to a seventh aspect of the present invention, the method of cleaning the printing mask further comprises a step for blasting the transfer surface of the printing mask with air, and a step for suctioning off contaminants adhering to the cleaning material.

The present invention thereby makes it possible to remove contaminants adhering to the transfer surface of the printing mask and, further, makes it possible to prevent the re-adherence of contaminants removed from the transfer surface of the printing mask, thereby making it possible to efficiently clean the transfer surface of the printing mask.

In addition, according to an eighth aspect of the present invention, a program for cleaning a printing mask comprises the computer execution of the steps of transferring an electrically conductive material formed on a printing mask to a continuous body along which a row of circuit blocks is arrayed; bringing a cleaning material into contact with a transfer surface of the printing mask; and conveying the cleaning material in a direction crosswise to the direction in which the continuous body is conveyed while rolling up the cleaning material that is brought into contact with the transfer surface.

Hence, when installed, the aforementioned cleaning program makes it possible to automatically execute cleaning of the printing mask along a direction other than that in which the continuous body is conveyed while the unused surface of the cleaning material is brought into contact with the transfer surface of the printing mask. While alleviating the need for a more complex hardware configuration for controlling cleaning, the cleaning program also makes it possible to shorten the time required for cleaning the printing mask.

### BRIEF DESCRIPTION OF THE DRAWINGS

FIG. 1 illustrates the method for manufacturing an electronic device in accordance with the first embodiment.

FIG. 2 illustrates the configuration of the apparatus for cleaning a printing mask in accordance with the second embodiment.

FIGS. 3(a)-(c) illustrate the method for cleaning the printing mask shown in FIG. 2.

### DETAILED DESCRIPTION

The apparatus for printing an electrically conductive material and the method for cleaning the printing mask according to preferred embodiments of the present invention are described below, with reference to drawings.

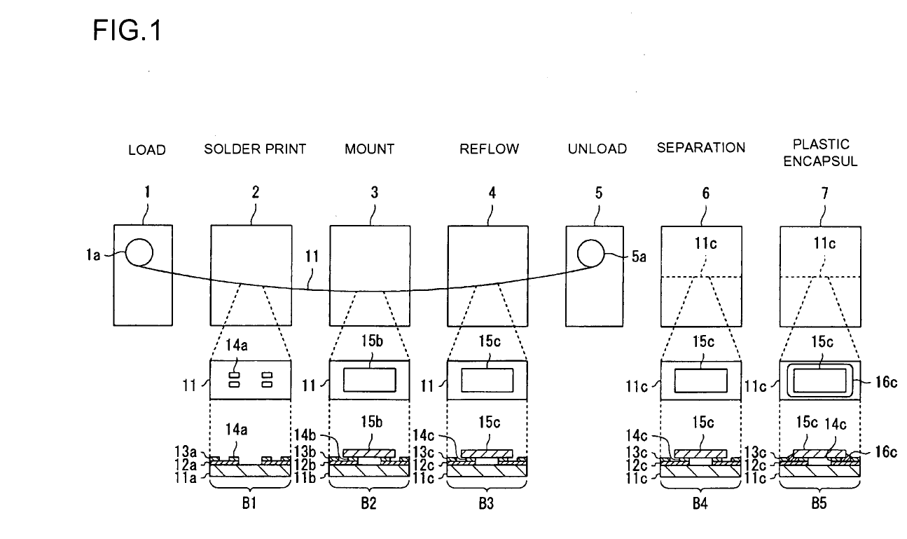

FIG. 1 illustrates a method for manufacturing an electronic device according to a first embodiment of the present invention.

In FIG. 1, between a loader 1 and an unloader 5, a solder coating zone 2, a mounting zone 3, and a reflow zone 4 are arranged side by side along the direction in which a tape substrate 11 is conveyed.

In addition, the tape substrate 11 includes an electronic component mounting zone in each of circuit blocks B1 to B3. Furthermore, circuit substrates 11a to 11c are each provided with the circuit blocks B1 to B3. Moreover, on the circuit substrates 11a to 11c, wiring 12a to 12c is formed. Insulating layers 13a to 13c are formed on the wiring 12a to 12c in such a way as to leave the terminal member of the wiring 12a to 12c exposed.

The circuit substrates 11a to 11c are of a predetermined length and are arrayed along the tape substrate 11. The tape substrate 11 spans from a feed reel 1a to a take-up reel 5a. Each TACT (total average cycle time) when the tape substrate 11 is conveyed forward in the tape substrate convey cycle, an as-yet unsoldered region of the tape substrate 11 is conveyed to the solder coating zone 2 installed between the loader 1 and the unloader 5. Meanwhile, a solder-coated region of the tape substrate 11 is conveyed to the mounting zone 3 arranged alongside the solder coating zone 2 while a component mounting region of the tape substrate 11 is conveyed to the reflow zone 4 arranged alongside the mounting zone 3.

Moreover, in the solder coating zone 2 solder paste pattern 14a is printed on the circuit substrate 11a; in the mounting zone 3 a semiconductor chip 15b is mounted on the circuit substrate 11b upon which the solder paste pattern 14b has been printed; and in the reflow zone 4 the circuit substrate 11c upon which the semiconductor chip 15c has been mounted is reflow processed. The semiconductor chip 15c is thereby secured to the circuit substrate 11c with the solder paste pattern 14c.

After all the circuit blocks B1 to B3 on the tape substrate 11 have been through the solder coating, mounting, and reflow steps, the tape substrate 11 is separated into the circuit blocks B1 to B3 in a separation zone 6. The separated circuit blocks B1 to B3 are then transferred to a resin encapsulation zone 7, where, for example, an encapsulating resin 16c is applied around the perimeter of the semiconductor chip 15c, thereby enabling resin encapsulation of the circuit block B3.

Accordingly, it is possible to complete the solder coating, mounting, and reflow processing of the circuit substrates 11a to 11c between the feed reel 1a and take-up reel 5a each time the tape substrate is conveyed forward. This also enables simultaneous solder coating, mounting, and reflow processing of the different circuit substrates 11a to 11c, thereby making it possible to increase production efficiency.

Furthermore, in each of the solder coating zone 2, mounting zone 3 and reflow zone 4, one of the circuit blocks B1 to B3 can be solder-coated, mounted, or reflow processed, respectively, per each convey TACT. However, it is also possible to solder-coat, mount, and reflow process a plurality of circuit blocks B1 to B3 in a single batch per each convey cycle. Here, to solder-coat the circuit blocks B1 to B3 in a batch process, the solder coating zone 2 can be provided with a printing mask whose length corresponds to the combined lengths of circuit blocks B1 to B3. The solder paste pattern 14a to 14c formed on the printing mask is transferred to the circuit blocks B1 to B3 in a batch process, thereby enabling the circuit blocks B1 to B3 to be printed with the solder paste pattern 14a to 14c in a batch process.

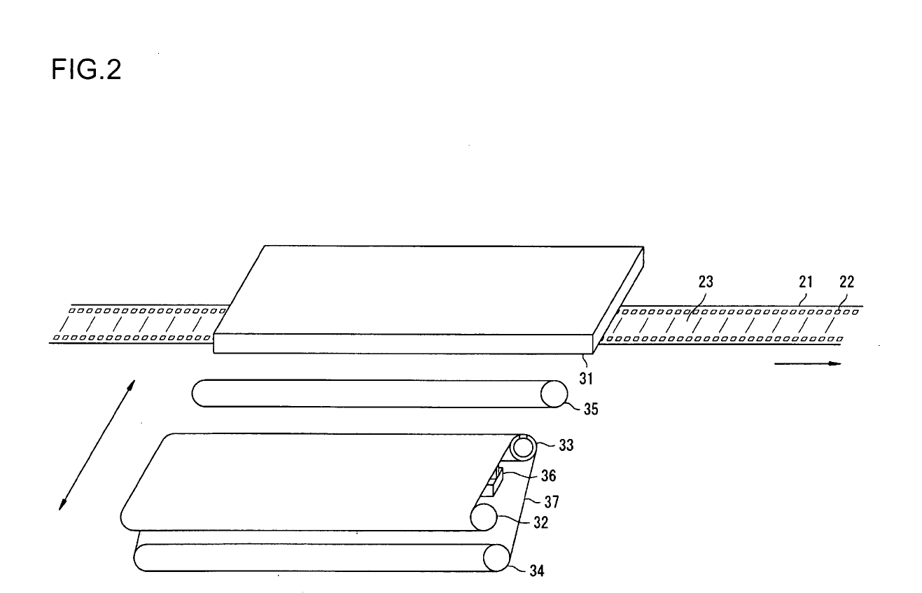

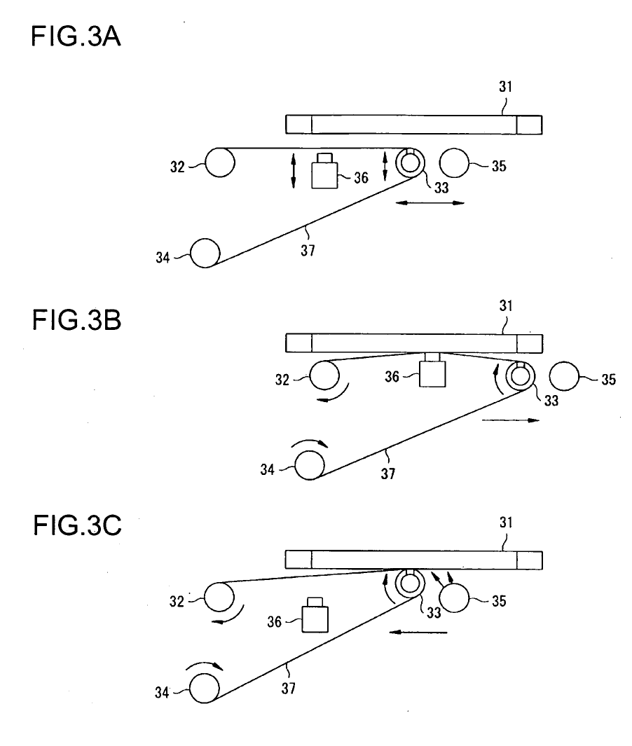

FIG. 2 is a perspective view illustrating the schematic configuration of the apparatus for cleaning a printing mask according to a second embodiment of the present invention. FIG. 3 is a side view illustrating a method of cleaning the printing mask illustrated in FIG. 2.

In FIG. 2 and FIG. 3, circuit blocks 23 are arranged in a continuous row along the lengthwise direction of a tape substrate 21, and each of the circuit blocks 23 has an electronic component mounting region. Along both side edges of the tape substrate 21, sprocket holes 22 for conveying the tape substrate 21 are provided at a predetermined pitch. The tape substrate 21 is made using a material such as polyimide, for example. A semiconductor chip, chip capacitor, resistive element, coil, connector, and the like are typical electronic components mounted on the circuit blocks 23.

If a solder paste pattern is to be printed on the circuit blocks 23 of the tape substrate 21, the conveyed tape substrate 21 is brought to a temporary halt in the solder coating zone 2 illustrated in FIG. 1. The solder paste pattern can be printed on the circuit blocks 23 by transferring the solder paste pattern formed on a printing mask 31 to the tape substrate 21.

Here, if it is desired that the solder paste pattern be printed on each of the circuit blocks 23, the length of the printing mask 31 can be extended along the lengthwise direction of the tape substrate 21, enabling the solder paste pattern to be batch-printed on a plurality of circuit blocks 23 in each convey cycle.

If the length of the printing mask 31 is 320 mm, the maximum length of the solder paste pattern region to be printed per convey TACT can be set to 320 mm, for example. Further, it is assumed for example that the pitch from center to center of any two (2) adjacent sprocket holes 22 in the tape substrate 21 is 4.75 mm and that the length of any one (1) of the circuit blocks 23 is not fixed and can be varied within a range equal to 6 to 15 pitches of sprocket holes 22. In this case, the length of the solder print region printed per convey TACT can be set so as to achieve the largest number of circuit blocks 23 within a range not exceeding a maximum of 320 mm. For example, if the length of one (1) circuit block 23 is equal to the length of eight (8) pitches of sprocket holes 22, the length of one (1) circuit block 23 would be 38 mm (4.75×8=38 mm), and the length of the solder print region printed per convey TACT can be made equal to the length of eight (8) circuit blocks 23, namely 304 mm ≦320 mm. Therefore, setting the length of the tape substrate 21 conveyed at each convey TACT at 304 mm enables eight circuit blocks 23 to be batch-soldered with the solder paste pattern per convey TACT.

On the other hand, the apparatus for cleaning the printing mask 31 is provided with a feed roller 32, a suction roller 33, and a take-up roller 34. Here, the feed roller 32, suction roller 33, and take-up roller 34 are arranged such that the rotational axis of each is along the direction in which the tape substrate 21 is conveyed. Moreover, the feed roller 32 and the suction roller 33 are arranged a predetermined distance apart from one another, and the take-up roller 34 is arranged below the feed roller 32. A cotton cleaning sheet 37 is fed out from the feed roller 32, passes over the suction roller 33, and is rolled up by the take-up roller 34. A solvent dispenser 36 is provided between the feed roller 32 and suction roller 33 for supplying a solvent such as an alcohol to the cotton cleaning sheet 37. An air blower 35 is provided alongside and parallel to the suction roller 33. The air blower 35 can be used to blast the transfer surface of the printing mask 31 with air.

The feed roller 32, suction roller 33, take-up roller 34, solvent dispenser 36 and air blower 35 are incorporated into a single unit. The feed roller 32, suction roller 33, take-up roller 34, solvent dispenser 36 and air blower 35 can move horizontally in an integral fashion in a direction perpendicular to the direction in which the tape substrate 21 is conveyed. Moreover, the suction roller 33 and the solvent dispenser 36 can be raised and lowered independent of one another.

Here, the rotational axis of each of the feed roller 32, suction roller 33, and take-up roller 34 is at least as long as the transfer face of the printing mask 31. Moreover, the width of the cotton cleaning sheet 37 is equal to or greater than the length of the transfer face of the printing mask 31.

When the transfer face of the printing mask 31 is to be cleaned, the printing mask 31 is moved so as to be positioned above the cotton cleaning sheet 37, as illustrated in FIG. 3(a).

As illustrated in FIG. 3(b), the solvent dispenser 36 is raised so as to push up the cotton cleaning sheet 37 from below, thereby wetting the cotton cleaning sheet 37 with a solvent while bringing the cotton cleaning sheet 37 into contact with the transfer surface of the printing mask 31. When the cotton cleaning sheet 37 comes into contact with the transfer surface of the printing mask 31, the feed roller 32, suction roller 33 and take-up roller 34 are rotated, thereby conveying the cotton cleaning sheet 37. While the cotton cleaning sheet 37 is being conveyed, the feed roller 32, suction roller 33, take-up roller 34, solvent dispenser 36 and air blower 35 are moved horizontally in an integral fashion in a direction perpendicular to the direction in which the tape substrate 21 is conveyed, thereby cleaning the transfer surface of the printing mask 31.

Thus it is possible to clean the printing mask 31 along the shorter, widthwise direction of the tape substrate 21 while an unused surface of the cotton cleaning sheet 37 is brought into contact with the transfer surface of the printing mask 31. Accordingly, even in cases where the printing mask is lengthened along the direction in which the tape substrate 21 is conveyed, increases in the travel distance of the cotton cleaning sheet 37 can be restrained, and the time required to clean the printing mask can be shortened.

Moreover, making the width of the cotton cleaning sheet 37 equal to or greater than the length of the transfer surface of the printing mask 31 allows the cotton cleaning sheet 37 to be brought into simultaneous contact with a plurality of circuit blocks 23, thereby enabling the transfer surface of the printing mask 31 to be batch-cleaned. Accordingly, even in cases where the length of the printing mask 31 corresponds to a length equivalent to the sum of a plurality of the circuit blocks 23, the time required to clean the printing mask 31 can be shortened, and the period during which the conveyance of the tape substrate 21 is halted can be shortened, thereby enabling production efficiency to be improved.

After the portion of the cotton cleaning sheet 37 that contacts the transfer surface of the printing mask 31 reaches the end edge of the transfer surface of the printing mask 31, the solvent dispenser 36 is lowered and the suction roller 33 is raised, as illustrated in FIG. 3(c). The suction roller 33 is then raised such that it presses against the transfer surface of the printing mask 31, with the cotton cleaning sheet 37 interposed therebetween. When the suction roller 33 is pressed against the transfer surface of the printing mask 31, the feed roller 32, suction roller 33 and take-up roller 34 are rotated, thereby conveying the cotton cleaning sheet 37. As the cotton cleaning sheet 37 is being conveyed, the feed roller 32, suction roller 33, take-up roller 34, solvent dispenser 36 and air blower 35 are moved horizontally toward their original location, thereby performing final cleaning of the printing mask 31.

Here, when the final cleaning of the printing mask 31 is performed, air is blasted from the air blower 35. While the transfer surface of the printing mask 31 is being blasted with air from the air blower 35, the suction roller 33 vacuums the printing mask 31, with the cotton cleaning sheet 37 interposed therebetween.

It is thereby possible to remove contaminants adhering to the transfer surface of the printing mask 31 and, further, to prevent the re-adherence of contaminants removed from the transfer surface of the printing mask 31. Hence, it is possible to efficiently clean the transfer surface of the printing mask 31.

Although the cleaning method described in the abovementioned embodiment includes only one unit including the feed roller 32, suction roller 33, take-up roller 34 and solvent dispenser 36, the method can in fact employ a plurality of units including the feed roller 32, suction roller 33, take-up roller 34 and solvent dispenser 36, and these units can share responsibility for cleaning the transfer surface of the printing mask 31.

What is claimed is:

1. An apparatus for printing an electrically conductive material, comprising:
a printing mask that transfers an electrically conductive material onto a continuous body along which a row of circuit blocks is arrayed; and
cleaning means that cleans a transfer surface of the printing mask, by conveying a cleaning material in a direction crosswise to a direction in which the continuous body is conveyed.

2. The apparatus for printing an electrically conductive material according to claim 1, wherein the cleaning means horizontally moves the cleaning material in a direction perpendicular to the direction in which the continuous body is conveyed.

3. The apparatus for printing an electrically conductive material according to claim 1, wherein a length of the printing mask corresponds to a length of a plurality of circuit blocks.

4. The apparatus for printing an electrically conductive material according to claim 1, wherein a width of the cleaning material is equal to or greater than a length of the transfer surface of the printing mask.

5. The apparatus for printing an electrically conductive material according to claim 1, wherein the cleaning means comprises:
a feed roller that feeds the cleaning material;
a take-up roller that rolls up the cleaning material;
a solvent dispenser that presses the cleaning material against the transfer surface of the printing mask while wetting the cleaning material fed out from the feed roller with a solvent;
a suction roller that catches and passes the cleaning material, and suctions off contaminants adhering to the cleaning material;
a horizontal transfer means that horizontally and integrally conveys the feed roller, the take-up roller, the suction roller, and the solvent dispenser;
a first vertical transfer means that raises and lowers the solvent dispenser; and
a second vertical transfer means that raises and lowers the suction roller.

6. A method for cleaning a printing mask, comprising:
transferring an electrically conductive material formed on a printing mask to a continuous body along which a row of circuit blocks is arrayed;
bringing a cleaning material into contact with a transfer surface of the printing mask; and
conveying the cleaning material in a direction crosswise to a direction in which the continuous body is conveyed while rolling up the cleaning material that is brought into contact with the transfer surface.

7. A method of cleaning the printing mask according to claim 6, further comprising:
blasting the transfer surface of the printing mask with air; and
suctioning off contaminants adhering to the cleaning material.

8. A program for cleaning a printing mask, comprising the computer execution of the steps of:
transferring an electrically conductive material formed on a printing mask to a continuous body along which a row of circuit blocks is arrayed;
bringing a cleaning material into contact with a transfer surface of the printing mask; and
conveying the cleaning material in a direction crosswise to a direction in which the continuous body is conveyed, while rolling up the cleaning material that is brought into contact with the transfer surface.

9. An apparatus for printing an electrically conductive material, comprising:
a printing mask that transfers an electrically conductive material onto a continuous body along which a row of circuit blocks is arrayed; and
a cleaning assembly that cleans a transfer surface of the printing mask, by conveying a cleaning material in a direction crosswise to a direction in which the continuous body is conveyed;
wherein the cleaning means comprises:
a feed roller that feeds the cleaning material;
a take-up roller that rolls up the cleaning material;
a solvent dispenser that presses the cleaning material against the transfer surface of the printing mask while wetting the cleaning material fed out from the feed roller with a solvent;
a suction roller that catches and passes the cleaning material, and suctions off contaminants adhering to the cleaning material;
a horizontal transfer mechanism that horizontally and integrally conveys the feed roller, the take-up roller, the suction roller, and the solvent dispenser;
a first vertical transfer mechanism that raises and lowers the solvent dispenser; and
a second vertical transfer mechanism that raises and lowers the suction roller.
